(19) United States
(12) Patent Application Publication
(10) Pub. No.: US 2020/0177512 A1
(43) Pub. Date: Jun. 4, 2020

(54) NETWORK ARCHITECTURE WITH CONTROL PLANE NODE

(71) Applicant: T-Mobile USA, Inc., Bellevue, WA (US)

(72) Inventor: Cameron Byrne, Seattle, WA (US)

(21) Appl. No.: 16/205,019

(22) Filed: Nov. 29, 2018

(51) Int. Cl. H04L 12/813; H04L 29/08; H04L 12/851; H04L 12/725; H04L 12/14; H04L 12/825; H04W 28/02

(52) U.S. Cl. CPC H04L 47/20; H04L 67/12; H04L 47/2483; H04W 28/0215; H04L 45/306; H04L 12/1428; H04L 47/263; H04L 45/302

(57) ABSTRACT

Techniques are described herein for providing control plane functions via a dedicated control plane node. The techniques include: receiving, from one or more processing entities, telemetry data of a user equipment, the one or more processing entities comprising an application-specific integrated circuit (ASIC); receiving, from a policy database, one or more policies for a subscription associated with the user equipment; determining, based at least partially on the telemetry data and the one or more policies, whether a certain QoS level is provided to the user equipment; and performing one or more control plane functions to enforce the certain QoS level.

### BACKGROUND

Field programmable gate arrays (FPGAs) and application-specific integrated circuits (ASICs) are widely used in networking and telecommunication systems. Both FPGAs and ASICs allow system designers to create silicon chips that implement their own design for a specific purpose rather than general-purpose chips that may not match their particular requirements. Because FPGAs and ASICs are application specific, they are able to perform a repeated function in an effective manner. In the network core, for instance, individual server elements include FPGAs or ASICs that perform a dedicated task.

In contrast, general-purpose chips such as central processing unit(s) (CPUs) and graphics processing unit(s) (GPUs) are able to provide various functions but perform in a less efficient manner. While FPGAs and ASICs can outperform general-purpose chips, FPGAs and ASICs typically include a limited logic and state tracking ability, particularly given the complex nature of a network architecture. Additionally, implementing FPGAs and ASICs generally require a large investment in engineering time and development costs. In this way, purchasing or building FPGAs or ASICs can be cost prohibitive in the event that its purpose becomes obsolete in the future.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example architecture for implementing a dedicated control plane node in a network environment.

FIG. 2 is a block diagram showing various components of an illustrative computing device that can provide control plane functions.

FIG. 3 is a flow diagram of an example process for performing one or more control plane functions from the perspective of a dedicated control plane node in a network.

FIG. 4 is a flow diagram of another example process for performing one or more control plane functions from the perspective of a dedicated control plane node in a network.

### DETAILED DESCRIPTION

This disclosure is directed to techniques for implementing one or more dedicated control plane nodes that are configured to receive telemetry data from one or more computing executives or processing entities comprising an FPGA or an ASIC. Each of the computing executives or processing entities is configured to perform a dedicated task. Because the FPGAs and ASICs typically include a limited logic and state tracking ability, it is resource intensive to perform various control plane functions that can be complex and unique to each network architecture.

The control plane nodes, in contrast, comprise one or more processing entities that may be a central processing unit(s) (CPU), graphics processing unit(s) (GPU), both a CPU and GPU or any other sort of processing unit(s). The control plane nodes can be easily scaled up or down depending on demand. Thus, the control plane nodes can perform various control plane functions in response to receiving the telemetry data. For example, the control plane nodes can support several functions such as access control, data packet routing and forwarding, mobility management, radio resource management, and user equipment reachability functions. In various embodiments, the control plane nodes can function as part of a core network. Additionally, or alternatively, the control plane nodes can be operatively coupled to the core network in order to communicate with one or more network elements.

For example, the control plane nodes can communicate with one or more policy engines for configuring user plane decisions such as video rate limiting, user billing, and data metering. The policy engines can comprise one or more policies related to a subscription associated with a profile associated with a user equipment that is serviced by a network. Based at least partially on one or more policies and/or the telemetry data received from FPGAs or ASICs, the control plane node can be configured to set a quality of service (QoS) value or level, limit or disconnect data flow, generate a billing record, update a billing record, and/or so forth.

Implementing control plane nodes decouples control plane functions from FPGAs or ASICs, thereby better allocating network element resources. Additionally, utilizing general-purpose computing allows control plane nodes to be easily scaled up or down without requiring a large investment in engineering time and development costs. The techniques described herein may be implemented in a number of ways. Example implementations are provided below with reference to the following figures.

### Example Network Architecture

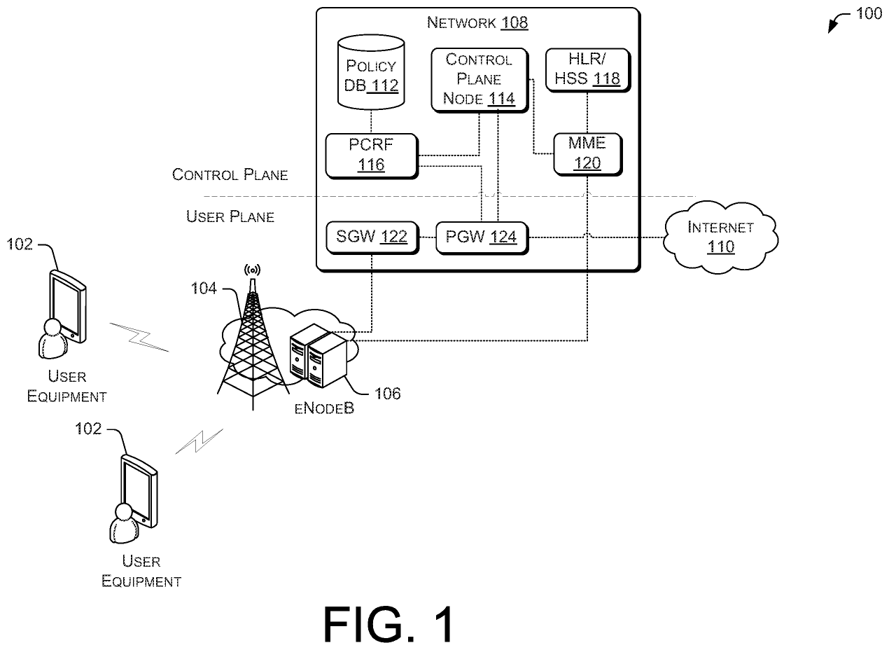

FIG. 1 illustrates an example architecture for implementing a dedicated control plane node to provide control plane functions in a network environment. The architecture may include one or more user equipment (UE) 102. The UE 102 can comprise smartphones, mobile devices, personal digital assistants (PDAs), desktop computers, laptops, tablets, smartwatches, or other electronic devices having a wireless communication function that are capable of receiving input, processing the input, and generating output data. The UE 102 is connected to a core network 108 via gateways utilizing one or more wireless base stations 104 or any other common wireless or wireline network access technologies.

The base station 104 can be a part of a radio access network (RAN). The base station 104 is configured to wirelessly interface with one or more of the UEs 102 to enable access to the core network 108, the Internet 110, and/or other networks. Each base station 104 may include one or more radio access nodes. In various embodiments, however, the base station 104 may include a base transceiver station (BTS) or a base station controller (BSC), a Node-B (NodeB), an evolved NodeB (eNodeB), a Home NodeB, a Home eNodeB, a site controller, an access point (AP), or a wireless router, or a server, router, switch, or other processing entity with a wired or wireless network. In the illustrated embodiment, the base station includes an eNodeB 106.

The UE 102 can connect to multiple networks and types of networks that provide a variety of services. For instance, the one or more networks may include a cellular network that implements 2G, 3G, 4G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet). Future technologies such as 6G and device-to-device (D2D) components could also be included and are contemplated herein.

The core network 108 can comprise various network elements, including a policy database 112, policy and charging rules function (PCRF) 116, a Home Location Register (HLR)/Home Subscriber Server (HSS) 118, a mobile management entity (MME) 120, a Serving Gateway (SGW) 122, and a Packet Data Network (PDN) Gateway (PGW) 124. The user plane network elements are the SGW 122 and the PGW 124. The control plane network elements are the policy DB 112, PCRF 116, HLR/HSS 118, and the MME 120. The processing entities of these network elements traditionally comprise a field programmable gate array (FPGA) or an application specific integrated circuit (ASIC) that is capable of executing specific computer programs or a series of commands, instructions, or state transactions. In this way, each piece of hardware of the network element performs a dedicated task.

The policy database 112 includes policies that define quality of service parameters to provide to the UE 102. The policy database 112 can also include other policies related to the subscription information associated with profile information associated with the UE 102. The PCRF 116 may determine policy rules in the network and access various databases (e.g., subscriber databases, a charging system, a billing system, etc.) in a streamlined manner. The PCRF 116 may aggregate information to and from the core network 108 and/or other sources. The PCRF 116 can support the creation of rules and then make policy decisions for each subscriber active on the network. The PCRF 116 can also be integrated with different platforms such as billing, rating, charging, and/or so forth.

The HLR/HSS 118 is a database that contains user-related and subscription-related information. The HLR/HSS 118 includes a user's telephone number (i.e., Mobile Subscriber Integrated Services Digital Network (MSISDN) number) and a user's International Mobile Subscriber Identity (IMSI) that uniquely identifies a subscriber. The IMSI can identify the subscription that is associated with a user. The IMSI includes the Mobile Country Code (MCC) and the Mobile Network Code (MNC). A copy of the IMSI is also stored on the subscriber identity module (SIM) card of the UE 102 that is associated with the subscribers. The HLR/HSS 118 also includes authentication information that is used to authenticate the subscriber and to generate encryption keys on a session basis, APNs the subscriber is allowed to use, IMS-specific information, and/or so forth. Thus, the functions of the HLR/HSS 118 include functionalities such as mobilities management, call and session establishment support, user authentication and access authorization, and/or so forth.

The MME 120 can register or unregister UEs 102 with the network, to establish user plane bearer channels, to hand off the UEs 102 to different eNodeBs 108, MMEs 126, other networks, and/or to perform other operations. The MME 120 may perform policing operations on traffic destined for and/or received from the UEs 102. The MME 120 may also authenticate a user by interacting with the HLR/HSS 118 and creating billing records.

The core network 108 can further comprise a control plane node 114. The control plane node 114 is a dedicated control node that can reside in the control plane of the network 108 or that can be communicably coupled to the control plane of the network 108. The control plane node 114 can comprise a plurality of physical machines such as general-purpose computers, such as desktop computers, tablet computers, laptop computers, servers (e.g., on-premise servers), or other electronic devices that are capable of receiving input, processing the input, and generating output data. The control plane node 114 may also comprise a plurality of virtual machines (e.g., virtual engines (VE), virtual private servers (VPS)). Unlike traditional network elements, the control plane node 114 includes one or more processing entities that may be a central processing unit(s) (CPU), graphics processing unit(s) (GPU), both a CPU and GPU or any other sort of processing unit(s). In this way, the control plane node 114 does not implement a System-on-Chip (SoC) that is built for a specific purpose. Instead, the control plane node 114 can perform a wide variety of functions to enable the network 108 to serve the UEs 102. Thus, the control plane node 114 can be automatically scaled according to demand and additional control plane nodes may be added without affecting the operation of the network 108.

The control plane node 114 is configured to receive telemetry data from one or more data sources, such as the UE 102, in order to perform control plane functions and/or facilitate control plane functions. Non-limiting examples of control plane functions include managing network traffic and user billing decisions. As used herein, all automated collection and communication of remote data from the UEs 102 and/or other data sources may be referred to as telemetry, and the collected data as telemetry data. In one example, telemetry data can include general usage statistics such as how often certain features or services are used, processing time, hardware utilized, and/or so forth. In another example, telemetry data can also include the number of bytes in User Datagram Protocol (UDP) flow when the Transmission Control Protocol (TCP) flow experiences a high delay, the UDP's flow priority, and/or so forth.

In various embodiments, the control plane node 114 may include one or more hardware components for aggregating telemetry data for UEs 102. The control plane node 114 may also implement a data management layer that includes software utilities for facilitating the acquisition, processing, storing, reporting, and analysis of data from multiple data sources. It is noted that the control plane node 114 is configured to collect telemetry data in accordance with various privacy regulations and laws. Thus, locally differentially private (LDP) algorithms or other tools may be used to estimate various population statistics while preserving privacy.

In various embodiments, the control plane node 114 may communicate directly with the UEs 102. Additionally, or alternatively, the control plane node 114 may communicate with various network elements such as the PCRF 116, the MME 120, and the PGW 124 to receive the telemetry data for the UEs 102. The control plane node 114 may communicate with the PCRF 116 via the Rx (or an extended Rx) interface. In one example, the control plane node 114 can communicate with the PCRF 116 to receive or transmit policies, wherein the policies can be stored in a policy database 112. Further, the control plane node 114 may communicate with other network components such as a wireless charging system (not pictured), depending upon embodiments.

The control plane node 114 is configured to perform one or more control plane functions upon receiving telemetry data from one or more network components and/or UEs 102. In this regard, the control plane node 114 can receive streaming telemetry data of the UE 102 from one or more processing entities (i.e., the network elements) of a telecommunications network. The processing entities can comprise FPGAs or ASICs as described above. Additionally, or alternatively, the control plane node 114 can query one or more processing entities to obtain telemetry data. The control plane node 114 may query the one or more processing entities on a scheduled basis. The control plane node 114 can also receive from a policy database, policies related to the subscription information associated with profile information associated with the UE 102. Based at least partially on the telemetry data and the policies, the control plane node 114 can facilitate or perform one or more control plane functions. In various embodiments, the control plane node 114 can receive telemetry data from multiple data sources to facilitate or perform respective control plane functions. For instance, the control plane node 114 can receive a first set of telemetry data from a first processing entity, and a second set of telemetry data from a second processing entity. Based at least partially on the first set of telemetry data and the policies, the control plane node 114 can facilitate or perform a first control plane function. Similarly, based at least partially on the second set of telemetry data and the policies, the control plane node 114 can facilitate or perform a second control plane function.

In one implementation, the control plane node 114 can handle control plane functions related to traffic sent to and from the PGW 124. For instance, the control plane node 114 may provide traffic management functions such as route modification for transmission routes of data sent to the Internet 110. Routing data can include classifying a packet classification and performing route optimization. Routing optimization can be based on the subscription information associated with profile information of the UE 102 or a user account associated with the UE 102. The user account can be associated with the profile information and the subscription information.

In various embodiments, the control plane node 114 can make decisions for route modification based at least partially on service related information such as QoS. The QoS describes properties or parameters for a new connection such as the minimum acceptable data rate or the maximum delay time allowed throughout the duration of the connection. Without limitations, the QoS parameters also include the following attributes of a network service such as packet loss, bit rate, throughput, transmission delay, availability, jitter, and/or so forth. The HLR/HSS 118 can store a QoS profile for each user that defines which Access Point Names (APNs) a user is allowed to use and/or the QoS level a user is allowed to request for a new connection.

The control plane node 114 can also perform traffic management functions based on subscription information associated with the UE 102. The subscription information includes the telecommunications services a subscriber is entitled to under a subscription. A subscription can be identified via the IMSI that is stored on the SIM card of the UE 102 that is associated with one or more subscribers. In various embodiments, the control plane node 114 can perform traffic management functions based on an application (e.g., voice applications, video applications, etc.) associated with packets of data. For instance, if a set of data is related to voice applications, the packets can have a specified QoS defined by the policy database.

In various embodiments, the control plane node 114 may apply various QoS levels to one or more UEs 102 based on the subscription associated with the UE 102, applications executed by the UE 102, and/or so forth. The QoS level means a specified QoS defined by the policy database. In order to establish a connection for a certain QoS level, the UE 102 can utilize an application interface for submitting a request for a QoS profile, which specifies a certain QoS level for a data flow. Based at least partially on the entitlement of the subscription with which the UE 102 is associated, the control plane node 114 or the control plane node 114 and the PCRF 116, can translate this request and send commands to the SGW 122 and the PGW 124, which in turn enforce the QoS profile request in the core network 108 and the access network. In various embodiments, the control plane node 114 may identify a frequency band or bandwidth that is suitable for providing the certain QoS level.

In another example, the control plane node 114 can receive usage data of the UE 102 to update billing systems. The control plane node 114 may communicate with the MME 120 to update billing records for a user account that is associated with the UE 102 based on the usage data of the UE 102. For instance, the control plane node 114 may update the billing records to indicate the amount of data that has been used up. Additionally, the control plane node 114 can provide rate limiting based on the usage data. More specifically, the control plane node 114 can implement rate limiting when the data usage exceeds a predetermined threshold.

### Example Computing Device Components

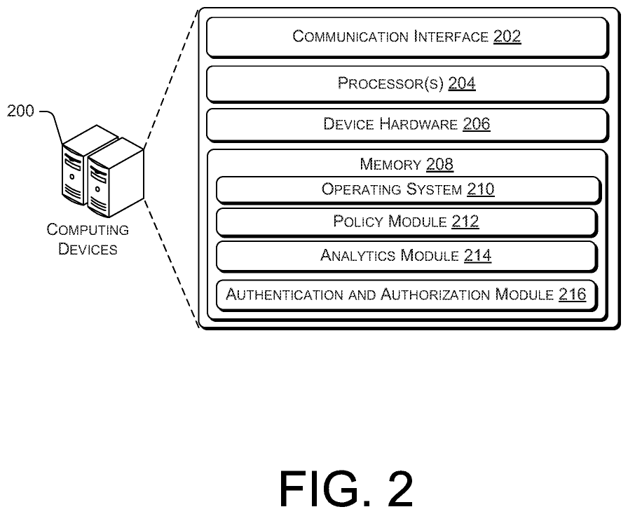

FIG. 2 is a block diagram showing various components of an illustrative computing device, wherein the computing device can comprise one or more control plane nodes. It is noted that the computing devices 200 as described herein can operate with more or fewer of the components shown herein. Additionally, the computing devices 200 as shown herein or portions thereof can serve as a representation of one or more of the computing devices of the present system.

The computing devices 200 may include a communication interface 202, one or more processors 204, hardware 206, and memory 208. The communication interface 202 may include wireless and/or wired communication components that enable the server 200 to transmit data to and receive data from other networked devices. In at least one example, the one or more processor(s) 204 may be a central processing unit(s) (CPU), graphics processing unit(s) (GPU), both a CPU and GPU or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 204 may also be responsible for executing all computer applications stored in the memory, which can be associated with common types of volatile (RAM) and/or nonvolatile (ROM) memory. The hardware 206 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 208 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, code segments, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, code segments, program modules, or other data in a modulated data signal, such as a carrier wave, or other transmission mechanisms. The memory 208 may also include a firewall. In some embodiments, the firewall may be implemented as hardware 206 in the server 200.

The processors 204 and the memory 208 of the server 200 may implement an operating system 210, a policy module 212, an analytics module 214, and an authentication and authorization module 216. The operating system 210 may include components that enable the server 200 to receive and transmit data via various interfaces (e.g., user controls, a communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The policy module 212 is configured to communicate with a policy database or other network database in order to store, query, or access policies that define parameters to provide services to one or more UEs. The policy database may include policies that identify one or more small cell sites at which certain traffic types are to be steered, current or dynamic performance threshold for cell sites eligible to receive pre-steered traffic, and/or so forth. In one instance, the policy module 212 can access the HLR/HSS 118 to access a QoS profile for a user to determine which Access Point Names (APNs) the user is allowed to use and/or the QoS level the user is allowed to request for a new connection.

The analytics module 214 is configured to analyze telemetry data received from one or more data sources such as one or more network elements, and/or other processing entities comprising FPGAs or ASICs in order to monitor network health and detect triggering events associated with one or more UEs. A triggering event can occur when one or more conditions with respect to the operations of the network occur. The conditions may be specific faults or issues that are detected with components of the network, deviation of actual performance indicators from predetermined threshold performance values, a number of user complaints regarding a network component, a network node, or a network service reaching or failing to reach a predetermined threshold, and/or so forth. A triggering event can also occur when data usage permitted under a subscription associated with a profile associated with a UE exceeds a predetermined threshold or a limit to which is allowed under the subscription. Additionally, a triggering event can occur when a control plane node (i.e., computing devices 200) receives a request (e.g., for a profile) from one or more UEs and/or network elements.

The authentication and authorization module 216 may provide user authentication and access authorization. In various embodiments, the authentication and authorization module 216 may interact with the HLR/HS S 118 to perform authentication using IMSI or other information. Additionally, the authentication and authorization module 216 can manage access authorization for a UE based at least partially on the telemetry data of the UE and one or more applicable policies in the policy database.

### Example Processes

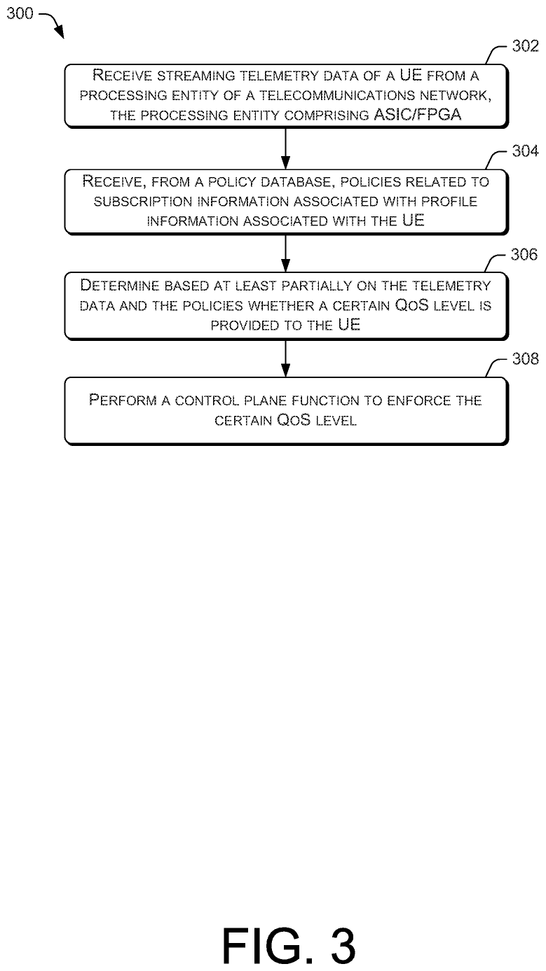

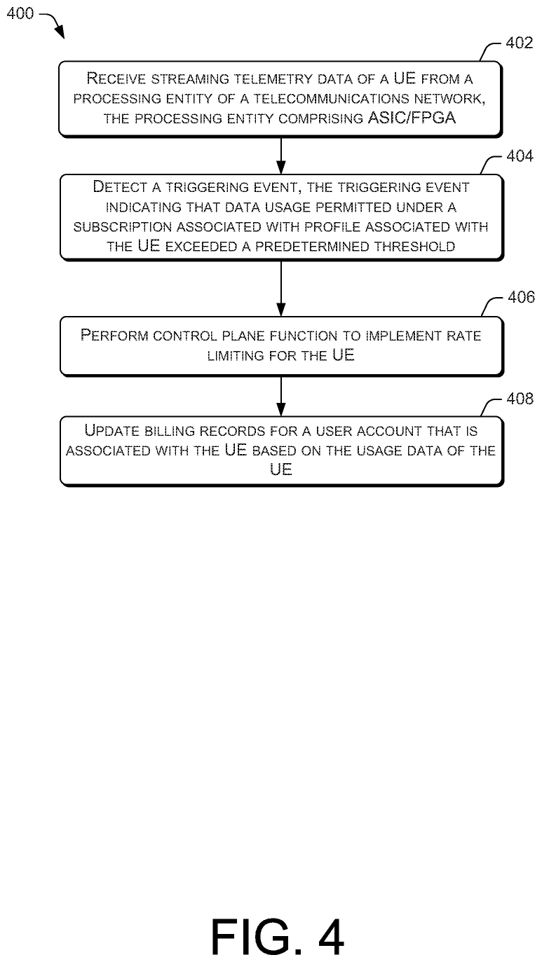

FIGS. 3 to 4 presents illustrative processes 300-400 for logging calls that are routed from an originating calling device to one or more terminating caller devices. The processes 300-400 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, code segments, and the like that perform particular functions or implement particular abstract data types. The order in which the operations are described is not intended to be construed as a limitation, and any number of the described blocks can be combined in any order and/or in parallel to implement the process. For discussion purposes, the processes 300-400 are described with reference to the network 100 of FIG. 1.

FIG. 3 is a flow diagram of an example process 300 for performing one or more control plane functions from the perspective of a control plane node. At block 302, the control plane node receives streaming telemetry data of a UE from a processing entity of a telecommunications network. The processing entity comprises an FPGA or an ASIC. At block 304, the control plane node may receive policies from a policy database. The policies can be related to subscription information associated with profile information associated with the UE. Thus, the policies can define parameters to provide services to the UE. At block 306, the control plane node can determine, based at least partially on the telemetry data and the policies, whether a certain QoS level is provided to the UE. In various embodiments, the control plane node can determine whether a certain QoS level is provided to the UE in response to detecting one or more event triggers. One or more event triggers can comprise receiving a request for a QoS profile from the UE.

At block 308, the control plane node may perform one or more control plane functions to enforce the certain QoS level. For instance, the control plane node or the control plane node and the PCRF can transmit commands to the gateways to enforce the QoS level in the core network and the access network. In various embodiments, the control plane node may identify a frequency band or bandwidth that is suitable for providing the certain QoS level. Additionally, the control plane node may perform a route modification based at least partially on an application (e.g., voice application, video application) associated with packets of data transmitted from the UE. In various embodiments, the control plane node may deny the request for the QoS profile in response to determining that the data usage exceeds the predetermined threshold.

FIG. 4 is a flow diagram of another example process 400 for performing one or more control plane functions from the perspective of a control plane node. At block 402, the control plane node receives streaming telemetry data of a UE from a processing entity of a telecommunications network, wherein the processing entity comprises a FPGA or an ASIC. In this regard, the control plane node may be configured to provide monitoring of mobile user data flow. At block 404, the control plane node may detect a triggering event. The triggering event can indicate that data usage permitted under a subscription associated with a profile associated with the UE exceeds a predetermined threshold. At block 406, the control plane node performs one or more control plane functions to implement rate limiting for the UE in response to determining that the data usage exceeded a predetermined threshold. At block 408, the control plane node may update the billing records for a user account that is associated with the UE based on the usage data of the UE. The user account can correspond to an account identifier that is associated with one or more users and user equipment.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. One or more non-transitory computer-readable media storing computer-executable instructions that upon execution cause one or more processors to perform acts comprising:
receiving, from one or more processing entities of a telecommunications network, telemetry data of a user equipment, the one or more processing entities comprising an application-specific integrated circuit (ASIC);
receiving, from a policy database, one or more policies for a subscription associated with the user equipment;
determining, based at least partially on the telemetry data and the one or more policies, whether a certain quality of service (QoS) level is provided to the user equipment; and
in response to the certain QoS level not being provided to the user equipment, performing one or more control plane functions to enforce the certain QoS level when the user equipment is connected to the telecommunications network.

2. The one or more non-transitory computer-readable media of claim 1, wherein the one or more processing entities include a first processing entity and a second processing entity, further comprising:
receiving a first set of telemetry data from the first processing entity;
receiving a second set of telemetry data from the second processing entity;
performing a first set of control plane functions based at least partially on the first set of telemetry data; and
performing a second set of control plane functions based at least partially on the second set of telemetry data.

3. The one or more non-transitory computer-readable media of claim 1, further comprising:
receiving a QoS profile request from the user equipment, the QoS profile request indicating a desired QoS level for data flow for the user equipment, and
wherein, the certain QoS level is based at least in part on the desired QoS level.

4. The one or more non-transitory computer-readable media of claim 1, wherein the one or more control plane functions comprise performing route modifications.

5. The one or more non-transitory computer-readable media of claim 1, wherein the telemetry data comprises information related to an application associated with packets of data transmitted from the user equipment, further wherein the one or more control plane functions comprise performing route modifications based at least partially on the application.

6. The one or more non-transitory computer-readable media of claim 5, wherein the application comprises a voice application or a video application.

7. The one or more non-transitory computer-readable media of claim 1, wherein the one or more non-transitory computer-readable media comprises an on-premise server.

8. The one or more non-transitory computer-readable media of claim 1, wherein the subscription corresponds with an account that is associated with a plurality of users and the user equipment.

9. A computer-implemented method, comprising:
receiving, from one or more processing entities of a telecommunications network, telemetry data of a user equipment, the one or more processing entities comprising an application-specific integrated circuit (ASIC);
receiving, from a policy database, one or more policies for a subscription associated with the user equipment;
determining, based at least partially on the telemetry data and the one or more policies, whether a certain quality of service (QoS) level is provided to the user equipment; and
in response to the certain QoS level not being provided to the user equipment, performing one or more control plane functions to enforce the certain QoS level when the user equipment is connected to the telecommunications network.

10. The computer-implemented method of claim 9, further comprising:
detecting, via the control plane node, a triggering event, the triggering event indicating that data usage permitted in accordance with the subscription associated with the user equipment exceeds a predetermined threshold; and
performing the one or more control plane functions to implement rate limiting for the user equipment.

11. The computer-implemented method of claim 10, further comprising:
receiving a QoS profile request from the user equipment, the QoS profile request indicating a desired QoS level for data flow for the user equipment; and
denying the QoS profile request in response to determining that the data usage exceeds the predetermined threshold.

12. The computer-implemented method of claim 9, further comprising:
updating billing records for a user account that is associated with the user equipment based on the telemetry data of the user equipment, wherein the telemetry data comprises usage data of the user equipment.

13. The computer-implemented method of claim 9, wherein the telemetry data comprises information related to an application associated with packets of data transmitted from the user equipment, further wherein the one or more control plane functions comprise performing route modifications based at least partially on the application.

14. The computer-implemented method of claim 9, wherein the one or more processing entities and the control plane node are different.

15. A system, comprising:
one or more non-transitory storage mediums configured to provide stored code segments, the one or more non-transitory storage mediums coupled to one or more processors, each configured to execute the code segments and causing the one or more processors to:
receive, from one or more processing entities of a telecommunications network, telemetry data of a user equipment, the one or more processing entities comprising an application-specific integrated circuit (ASIC);
receive, from a policy database, one or more policies for a subscription associated with the user equipment;
determine, based at least partially on the telemetry data and the one or more policies, whether a certain quality of service (QoS) level is provided to the user equipment; and
perform one or more control plane functions to enforce the certain QoS level when the user equipment is connected to the telecommunications network.

16. The system of claim 15, wherein the one or more processors are further configured to:
receive a QoS profile request from the user equipment, the QoS profile request indicating a desired QoS level for data flow for the user equipment;
approve the QoS profile request based at least partially on the one or more policies; and
perform the one or more control plane functions to enforce the desired QoS level, wherein, the certain QoS level is based at least in part on the desired QoS level.

17. The system of claim 16, wherein the one or more processors are further configured to:
update billing records for a user account that is associated with the user equipment to indicate the desired QoS level.

18. The system of claim 15, wherein the one or more processors are further configured to:
perform the one or more control plane functions to implement rate limiting for the user equipment in response to determining that one or more conditions with respect to one or more operations of the telecommunications network are met.

19. The system of claim 15, wherein the telemetry data comprises information related to an application associated with packets of data transmitted from the user equipment, further wherein the one or more control plane functions comprise performing route modifications based at least partially on the application.

20. The system of claim 19, wherein the one or more processors are further configured to:
perform the one or more control plane functions to implement rate limiting for the user equipment based at least partially on the application.
